(19) United States
(12) Patent Application Publication
(10) Pub. No.: US 2025/0298192 A1
(43) Pub. Date: Sep. 25, 2025

(54) High-Density Optical Coupling

(71) Applicant: Teramount Ltd., Jerusalem (IL)

(72) Inventors: Abraham Israel, Jerusalem (IL); Hesham Taha, Jerusalem (IL); Aysha Shaloudi, Jerusalem (IL); Elad Schleifer, Shoham (IL); Shay Faivush Ulfan, Beit Hashmonai (IL)

(21) Appl. No.: 19/084,194

(22) Filed: Mar. 19, 2025

Related U.S. Application Data
(60) Provisional application No. 63/568,113, filed on Mar. 21, 2024.

(51) Int. Cl. G02B 6/36; G02B 6/42

(52) U.S. Cl. CPC G02B 6/3652; G02B 6/3676; G02B 6/4214

(57) ABSTRACT

Systems, apparatuses, and methods for detachable fiber connector (FC) for optical coupling based on a coarse alignment and fine alignment are described. A photonic plug may be horizontally inserted into a receptacle and coarsely aligned with a photonic integrated circuit (PIC). The photonic plug may be moved vertically in the direction of the PIC. First fine alignment features, of the photonic plug, may engage second fine alignment features, associated with the PIC, aligning the photonic plug and the PIC. Systems, Mechanisms, and methods for retaining and for releasing the detachable connectors are also described.

### CROSS-REFERENCE TO RELATED APPLICATIONS

This Application claims the benefit of and priority to U.S. Provisional Application No. 63/568,113, filed on Mar. 21, 2024, and titled “High-Density Optical Coupling.” The contents of the aforementioned application are incorporated herein in their entirety.

### BACKGROUND

Data is ubiquitous. In data transfer and computing, space and bandwidth density are at a premium.

### SUMMARY

The following summary presents a simplified summary of certain features. The summary is not an extensive overview and is not intended to identify key or critical elements.

Systems, apparatuses, and methods are described for increasing optical coupling bandwidth density. The couplers may comprise a substrate, for example, a photonic plug. The substrate may be connected to a first plurality of optical components (e.g., a first layer of optical fibers) and a second plurality of optical components (e.g., a second layer of optical fibers). The second plurality of optical components may be layered on the first plurality of optical components. The substrate may facilitate optical coupling of the first and second pluralities of optical components to one or more third optical components. The one or more third optical components may comprise one or more photonic integrated circuits and/or one or more additional optical fibers. The substrate may comprise one or more optical elements, for example, mirrors, for example, to facilitate optical coupling of the layered optical components. The substrate may comprise multiple rows of optical elements. The substrate may comprise a first row of optical elements corresponding to the first plurality of optical components and a second row of optical elements corresponding to the second plurality of optical elements, etc. In this manner, bandwidth density may be substantially increased with a minimal increase in coupler footprint.

These and other features and advantages are described in greater detail below.

### BRIEF DESCRIPTION OF THE FIGURES

FIGS. 1A and 1B depict an example photonic plug.

FIGS. 2A, 2B, and 2C show example photonic plugs with optical fibers.

FIG. 3 depicts a cross-section view of an example photonic plug with optical fibers.

FIG. 4 depicts an example photonic plug system.

FIGS. 5A and 5B show example multi-layer optical coupling systems.

FIG. 5C shows an example multi-layer optical coupling system.

FIG. 6 shows an example multi-layer optical coupling system.

FIG. 7 shows an example multi-layer optical coupling system.

FIG. 8 shows fiber ribbon connected to a photonic plug and connectors.

### DETAILED DESCRIPTION

The accompanying drawings, which form a part hereof, show examples of the disclosure. It is to be understood that the examples shown in the drawings and/or described herein are non-exclusive and that there are other examples of how the disclosure may be practiced.

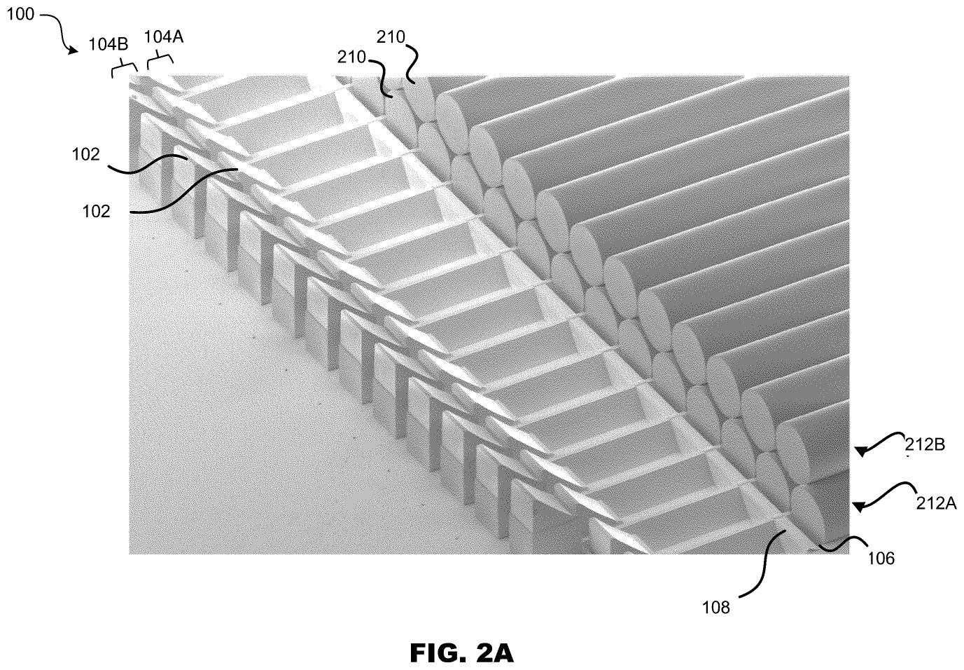

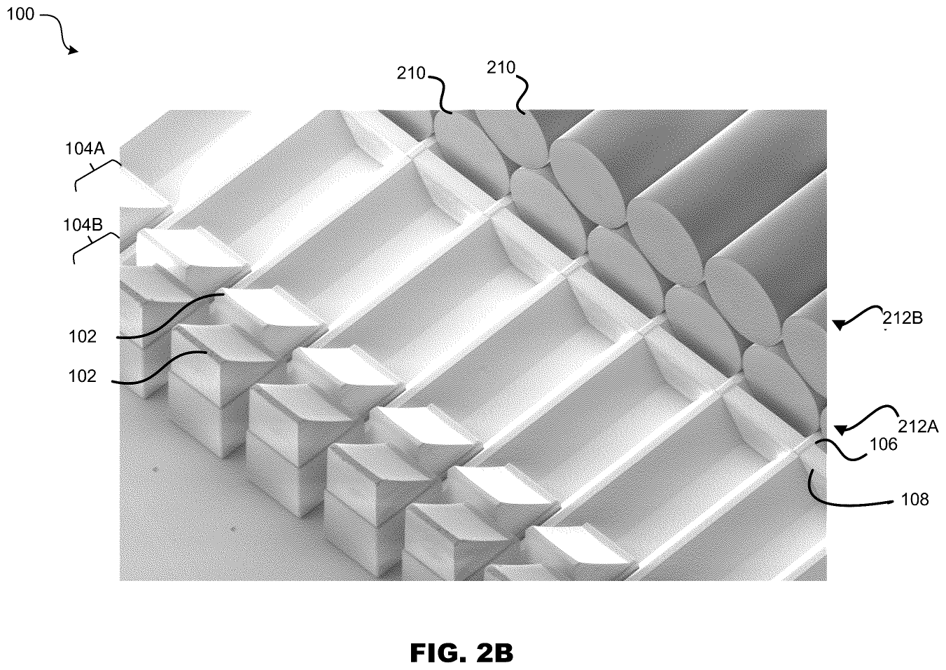

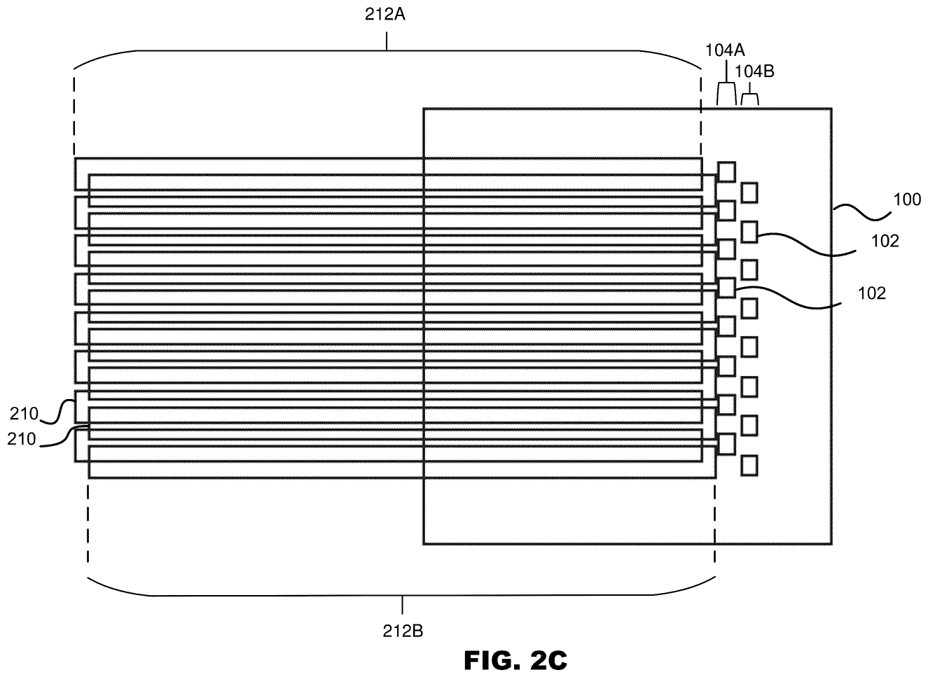

Bandwidth and bandwidth density are at a premium in data communications (e.g., optical data communication). With respect to optical communications in general, the more optical connections available (e.g., the more optical fibers available), the higher the available and/or potential bandwidth. Similarly, the more bandwidth available per given area, the higher the bandwidth density. If connecting a first plurality of fibers to a second plurality of fibers, and/or if connecting a plurality of fibers to a chip (e.g., a photonic integrated circuit (PIC)), the plurality of fibers may be arranged laterally (e.g., as depicted in FIGS. 2A and 2B). On a connector and/or a chip, the two edges (and/or distance between the two edges) of a plurality of laterally arranged optical components (e.g., fibers) may be referred to as shorelines. In such an arrangement, the shoreline may expand with every laterally added component. For example, considering an optical fiber ribbon connector, the shoreline of the connector may expand by at least the diameter of an optical fiber with every added fiber. Such shoreline expansion for added bandwidth may be associated with increased costs.

The present disclosure describes apparatuses, methods, and systems for increasing shoreline density and bandwidth density with reduced cost. For example, the present disclosure describes increasing shoreline and bandwidth density without increasing the shoreline or shoreline distance. The apparatuses, methods, and systems of the present disclosure increase shoreline density by, for example, providing multi-layered optical connection. By layering optical connections, shoreline density and bandwidth density may be significantly increased with a relatively small increase in footprint. For example, using the techniques of the present disclosure, the shoreline density of an optical fiber connector may be about double with an increase in footprint of less than the diameter of a single fiber. Therefore, using the techniques of the present disclosure, shoreline density and bandwidth density may be significantly improved with reduced space and cost requirements.

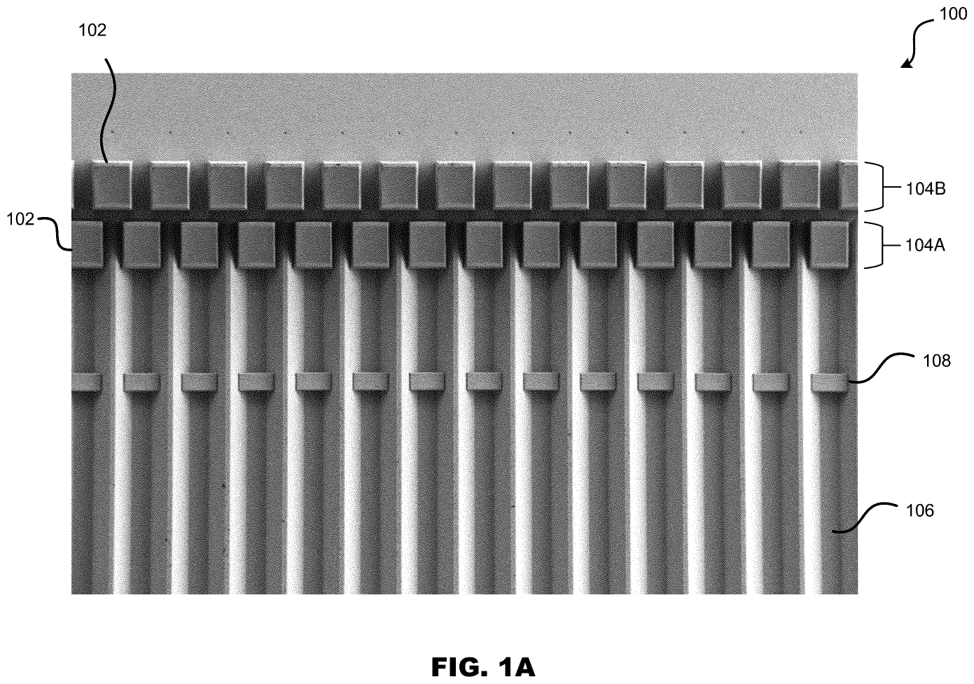

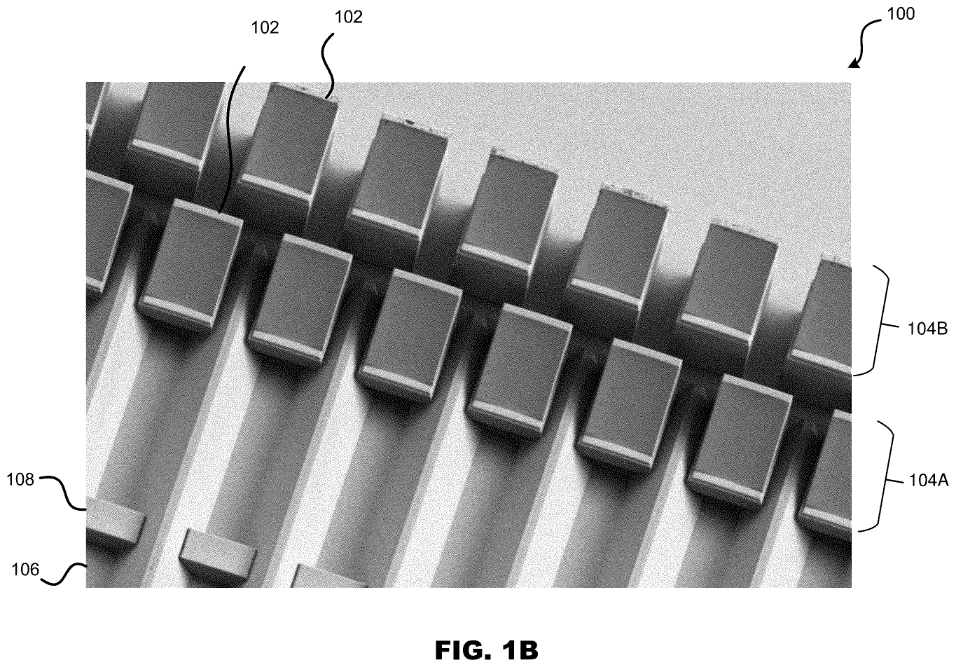

FIGS. 1A and 1B depict an example photonic plug 100. Referring to FIGS. 1A and 1B, the photonic plug 100 may be a multi-layer photonic plug. The photonic plug 100 may be used to optically couple one or more optical components and/or elements as further described herein. The photonic plug 100 may comprise a substrate. The substrate may comprise, for example, one or more of a silicon substrate, a metal substrate, a plastic substrate, a silicon photonic (SiPh) substrate, a glass substrate, a polymer substrate, etc. The photonic plug 100 may comprise one or more optical elements, for example, mirrors 102 (for clarity, only two mirrors 102 of a plurality of mirrors 102 are referenced in FIGS. 1A and 1B). The mirrors 102 may be angled (e.g., tilted, turning, etc.). For example, the mirrors 102 may be disposed on the photonic plug 100 at an angle (e.g., a predefined angle) with respect to the underlying substrate. The mirrors 102 may be angled to direct (e.g., redirect) light beams (e.g., optical signals) as described in more detail herein. The mirrors 102 may interact with light (e.g., a light beam) and may facilitate coupling (e.g., optical coupling) of the light between optical components (e.g., optical fiber, a photonic integrated circuit (PIC), etc.). In some example configurations, the mirrors may be substantially flat. Substantially flat mirrors may turn (e.g., direct, redirect) a light beam. In other example configurations, the mirrors 102 may be angled and curved. Such mirrors 102 may be referred to as turning curved mirrors (TCM) or lensed mirrors. TCM mirrors may be used to redirect and transform a light beam. For example, the TCM mirrors may collimate, focus, and/or expand a light beam, as described in more detail herein.

The photonic plug 100 may comprise a multi-layer photonic plug. The photonic plug 100 may comprise a first row of mirrors 104A and a second row of mirrors 104B. The first row of mirrors 104A may be used to facilitate optical coupling of a first plurality of optical components. The second row of mirrors 104B may be used to facilitate optical coupling of a second plurality of optical components. The second plurality of mirrors 104B may be offset and or staggered. For example, the first and second rows of mirrors 104A and 104B may be disposed such that the substantial midline of a mirror 102 of the second row of mirrors 104B may be disposed substantially in the middle of two mirrors 102 of the first row of mirrors 104A. Alternatively, the mirrors 102 of the first row of mirrors 104A and the mirrors 102 of the second row of mirrors 104B may be substantially aligned. The second row of mirrors 104B may, also or alternatively, be height offset from the first row of mirrors 104A (as described in more detail herein). FIGS. 1A and 1B depict all mirrors 102 of the first and second rows of mirror 104A and 104B as separate distinct mirrors 102. Alternatively, the mirrors 102 of the first and/or second row may comprise a single contiguous mirror 102, for example, facilitating optical connection of a plurality of optical components. Also or alternatively, FIG. 1 depicts the first row of mirrors 104A and the second row of mirrors 104B as separate. Alternatively, the first and second rows of mirrors 104A and 104B may comprise a single mirrored surface. The groupings of the mirrors 102 of the first row of mirrors 104A and the groupings of the mirrors 102 of the second row of mirrors may be variously divided.

The mirrors 102 and other elements may be fabricated on and or with the photonic plug 100 substrate at volume and may leverage ecosystems and workflows, for example, for example, using complementary metal-oxide-semiconductor (CMOS) processes, silicon-on-insulator (SOI) processes, nanoimprint lithography (NIL), grayscale lithography, hot embossing, photoresist additive manufacturing, etc. The mirrors 102 may be fabricated on the photonic plug 100 substrate. Also or alternatively, the mirrors 102 may be fabricated with the photonic plug 100 substrate. Also or alternatively, the mirrors 102 may be fabricated separately from the photonic plug 100 substrate. In such a configuration, the micro-assembly workflows may be leveraged to assemble the mirrors 102 to the photonic plug 100 substrate. Also or alternatively, mirror receiving trenches (e.g., v-grooves) may be etched into the photonic plug 100 substrate and a separately produced mirror 102 may be assembled to the photonic plug 100 substrate guided and aligned via the mirror receiving trenches.

The photonic plug 100 may comprise one or more trenches 106. The trenches 106 may be configured to align and/or retain one or more optical components. For example, each trench 106 may be configured to align and/or retain an optical fiber (as depicted, for example, in FIGS. 2A and 2B). The fiber trenches may be configured as v-grooves, u-grooves, circular grooves (e.g., having a circular cross-section), semi-circular grooves (e.g., having a semi-circular cross-section), square grooves, etc., or any combination thereof.

The photonic plug 100 may further comprise one or more stop blocks 108 (for clarity, only one stop block 108 of a plurality of stop blocks 108 is referenced in FIG. 1). Each of the stop blocks 108 may be disposed in and/or at an end of a corresponding trench 106. The stop blocks 108 may be configured to limit a movement of an optical component (e.g., optical fiber), for example, that is disposed in and/or connected to a corresponding trench 106. For example, each stop block 108 may limit a movement (e.g., an axial movement) of an optical fiber, with respect to a corresponding mirror 102, in the corresponding trench 106. The stop block 108 may be used to ensure that the optical component (e.g., optical fiber) is properly (e.g., suitably, effectively, etc.) positioned from the corresponding mirror 102 to effectuate the optical connections as discussed herein.

FIG. 1B is an alternate view of the example photonic plug 100 of FIG. 1A. Referring to FIG. 1B, it can be seen that the first row of mirrors 104A and the second row of mirrors 104B (e.g., a center point or substantial center point of the mirrors) may be disposed at different heights (e.g., distances) from a surface of the photonic plug 100 substrate. For example, in an example configuration comprising 125 μm fiber diameters, the height difference between the first row of mirrors 104A and second row of mirrors 104B may be about 100 μm.

FIGS. 2A, 2B, and 2C show example photonic plugs 100 with optical fibers 210. As described above with respect to FIGS. 1A and 1B, the photonic plug 100 can be used to optically connect optical components (e.g., optical fiber(s) to optical fiber(s), optical fiber(s) to chip(s), chip(s) to chip(s)). Optical fibers 210 may be placed and or disposed in trenches 106. Trenches 106 may laterally align a corresponding optical fiber 210 with a corresponding mirror 102. The fiber 210 may abut a corresponding stop block 108 (e.g., end stop), for example, to maintain a desired and/or operable distance of the fiber 210 and the corresponding mirror 102.

As described, the photonic plug 100 may comprise a dense, multi-layered photonic plug 100 effecting optical connection of a plurality of layers of optical fibers 210. For example, referring to FIGS. 2A and 2B, a first fiber layer 212A may be disposed on the photonic plug 100. Each fiber 210 of the first fiber layer 212A may be disposed on and/or in a corresponding trench 106 (e.g., v-groove). A second fiber layer 212B may be disposed on the first layer 212A. Two adjacent fibers 210 may define a space (e.g., a channel) therebetween, for example, on a topside of the adjacent fibers. Accordingly, the channels between two adjacent fibers 210 of the first fiber layer 212A may comprise a trench for a fiber 210 of the second fiber layer 212B. Accordingly, the alignment of the fibers 210 of the first fiber layer 212A in the trenches 106 may be transposed to the fiber 210 of the second fiber layer 212B. Thereby, the fibers 210 of the second fiber layer 212B may be aligned with a corresponding mirror 102 of the second row of mirrors 104B.

The distance of the fibers 210 of the first fiber layer 212A to the first row of mirrors 104A may be different from the distance of the fibers 210 of the second fiber layer 212B to the second row of mirrors 104B. Accordingly, the mirrors 102 of the first row of mirrors 104A may have a different optical design (e.g., focal length) from the mirrors 102 of the second row of mirrors 104B, for example, to account for the differences in fiber distance.

In this regard, the density of connections effected by the photonic plug 100 can be nearly doubled (e.g., doubled minus 1) with an increased footprint in the z-direction of less than the diameter of a single fiber 210. Although FIGS. 2A and 2B only depict a two-layer photonic plug 100; it will be appreciated that the concepts could be extended to additional layers. Each additional layer may comprise the number of connections of the previous layer minus 1.

FIG. 2C depicts an example photonic plug 100. As described herein, the features of the present disclosure may be used to optically couple optical fibers 210, for example, via mirrors 102. Further, as described herein, ends of fibers 210 of the first fiber layer 212A and ends of fibers 210 of the second fiber layer 212B may be substantially aligned (e.g., as depicted in FIGS. 2A and 2B). Referring to FIG. 2C, ends of fiber 210 of the first fiber layer 212A and ends of fiber 210 of the second fiber layer 212B may be offset. For example, as described in reference to FIGS. 2A and 2B, the fibers 210 of the first fiber layer 212A may abut stop blocks (e.g., stop blocks 108 in FIGS. 2A and 2B). Referring to FIG. 2C, the second fiber layer 212B may be disposed on top of the first fiber layer 212A. The fibers 210 of the second fiber layer 212B may be offset, for example, in an axial direction, in relation to the fibers 210 of the first fiber layer 212A. The fibers 210 of the second fiber layer 212B may be moved axially toward the mirrors 102. The fibers 210 of the second fiber layer 212B may abut mirrors 102 of the first row of mirrors 104A. The fibers 210 of the second fiber layer 212B may abut two neighboring mirrors 102 of the first row of mirrors 104A. The first row of mirrors 104A may act as a stop block (e.g., substantially as described with reference to stop block 108) for the fibers 210 of the second row of fibers. Abutting the first row of mirrors 104A may distance (e.g., at the designed distance) the fibers 210 of the second fiber layer 212B from their corresponding mirrors 102 of the second row of mirrors 104B.

Fibers 210 may comprise, for example, single mode (SM) fibers, polarization-maintaining (PM) fibers, multimode (MM) fiber, etc. A single photonic plug 100 can be connected to multiple different types of fibers 210. For example, a single photonic plug 100 may connected to one or more SM fibers and one or more PM fibers, for example, to connected to different types of optical components.

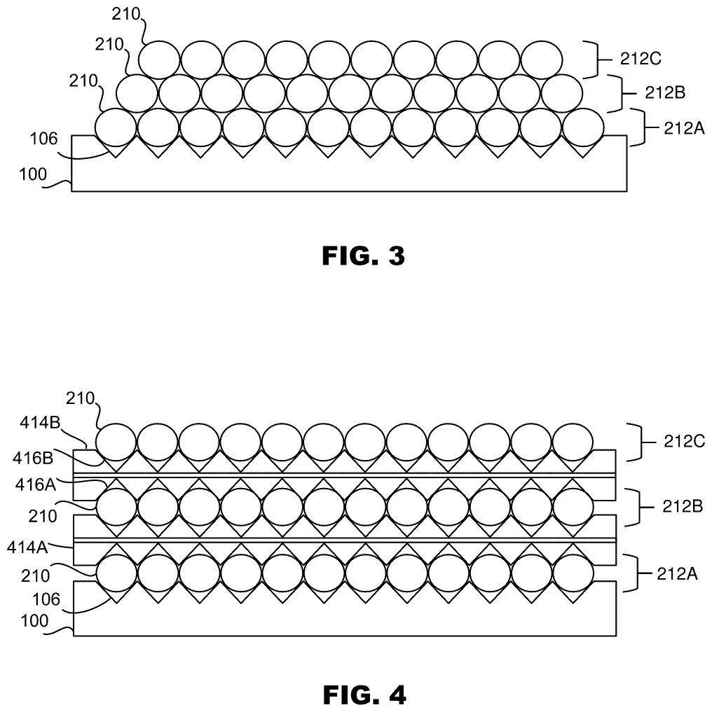

FIG. 3 depicts a cross-section view of an example photonic plug 100 with optical fibers 210. FIG. 3 depicts a fiber arrangement similar to that of FIGS. 2A and 2B. Referring to FIG. 3, fiber 210 of the first fiber layer 212A may be disposed in trenches 106 of the photonic plug 100. The trenches 106 may facilitate alignment of the fiber 210 therein with respect to an optical element (e.g., a mirror, a lens, etc.). The optical element may be configured to effect and/or facilitate optical connection. Fibers 210 of the second fiber layer 212B may be disposed on the first fiber layer 212A. The voids and/or channels defined between two adjacent fibers 210 of the first fiber layer 212A may facilitate alignment of the fiber 210 therein. Accordingly, the alignment provided by the trenches 106 may be transferred (e.g., imparted, relayed) to the fibers 210 of the second fiber layer 212B (and any subsequent layers, e.g., third fiber layer 212C, etc.), for example, via the first fiber layer 212A. In this arrangement, if the first fiber layer 212A comprises X number of fibers, each subsequent layer (L) may comprise one fewer fiber than the previous layer. Accordingly, the number (N) of fibers 210 in a layer (L) may be defined as N=X−(L−1). Alternatively, and as depicted, for example, in FIG. 2C, the quantity of fibers of an upper layer (e.g., second fiber layer 212B) may be the same as the quantity of fibers of the lower fiber layer (e.g., first fiber layer 212A). Alternatively, the quantity of fibers 210 in an upper layer (e.g., second fiber layer 212B) may be more than the quantity of fibers in a lower layer (e.g., first fiber layer 212A). Accordingly, bandwidth can be significantly increased with a small increase in space (e.g., footprint). Accordingly, the systems, methods, and apparatuses of the present disclosure may be used to increase bandwidth density for optical connection. FIG. 3 depicts an example configuration comprising three fiber layers (first fiber layer 212A, second fiber layer 212B, and third fiber layer 212C). However, more or less fiber layers are contemplated.

FIG. 4 depicts an example photonic plug 100 system. Referring to FIG. 4, the photonic plug 100 system may comprise a photonic plug 100 comprising a plurality of trenches 106. Each fiber 210 of a first fiber layer 212A may be disposed in a corresponding trench 106. The photonic plug 100 system may further comprise separation substrates 414A and 414B (generally, separation substrate 414). Separation substrates 414 may be fabricated from, for example, metal, silicon, polymers, glass, etc. The separation substrates 414 may comprise first separation trenches 416A (e.g., substantially similar to trenches 106 unless explicitly described herein) in a first surface of the separation substrate 414. The separation substrates 414 may further comprise second separation trenches 416B in a second surface of the separation substrate 414. The second surface may be substantially opposed to the first surface.

The separation substrates 414 may be configured to separate fiber layers 212. Each separation substrate may be disposed between two fiber layers 212. The first separation trenches 416A (e.g., of separation substrate 414A) may engage a lower fiber layer 212 (e.g., fiber layer 212A). For example, each of the first separation trenches 416A may engage a fiber 210 of the lower fiber layer 212. An upper fiber layer 212 (e.g., second fiber layer 212B) may be disposed in and/or on the second separation trenches 416B (e.g., of the first separation substrate 414A). For example, each fiber 210 of an upper fiber layer 212 may be disposed in a corresponding one of upper separation trenches 416A. Accordingly, the upper fiber layer (e.g., second fiber layer 212B) may be aligned and maintained via a separation substrate. A fiber layer 212 (e.g., second fiber layer 212B) may be the described lower and upper fiber layers 212. FIG. 4 depicts three fiber layers 212. In other configurations, the system may comprise more or less fiber layers 212. Further, FIG. 4 depicts each fiber layer 212 comprising the same quantity of fibers 210. In other configurations, different fiber layers 212 may comprise different quantities of fibers 210.

The separation substrates 414 may further comprise stop blocks (e.g., substantially similar to stop block 108 unless otherwise explicitly described). The separation substrate stop blocks may be disposed in the separation trenches 416. Each of the separation substrate stop blocks may be configured to abut a corresponding fiber 210, for example, disposed in a corresponding separation trench 416. The separation substrate 414 may comprise stop blocks on an upper side and a lower side. For example, the first separation substrate 414A may comprise stop blocks to engage a lower fiber layer 212 (e.g., first fiber layer 212A) and to engage an upper fiber layer 212 (e.g., second fiber layer 212B). The stop blocks may facilitate positioning of the separation substrate 414 as well as the fibers 210 engaged with the separation substrate 414.

Referring to FIG. 2A, FIG. 2B, FIG. 3, and FIG. 4, the fibers 210 may be connected, adhered, and/or otherwise retained with the photonic plug 100 substrate. For example, adhesive (e.g., epoxy, glue) may be disposed on the photonic plug 100 and the connected optical fibers 210. The adhesive may retain the fibers 210 to the photonic plug 100 substrate. Adhesive can be applied per fiber layer 212 and between fiber layers 212. Also or alternatively, adhesive can be applied to multiple fiber layers 212 disposed on a photonic plug 100, substrate. Also or alternatively, a glass substrate (e.g., a spacer) may be configured in shape to correspond to the shape of the photonic plug 100 and connected fiber layers 212. The glass substrate may be disposed against the fiber layers 212 and the photonic plug 100 substrate, for example, sandwiching (e.g., encasing, enveloping) the portion of the optical fibers 210 between the glass layer and the photonic plug 100 substrate. The fibers 210 may be additionally or alternatively retained to the photonic plug 100. For example, the fibers 210 may be clipped to the photonic plug 100.

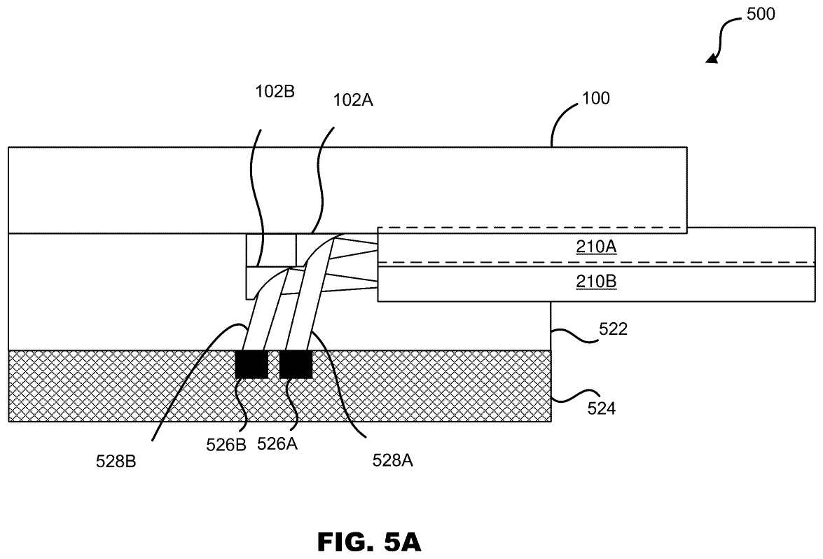

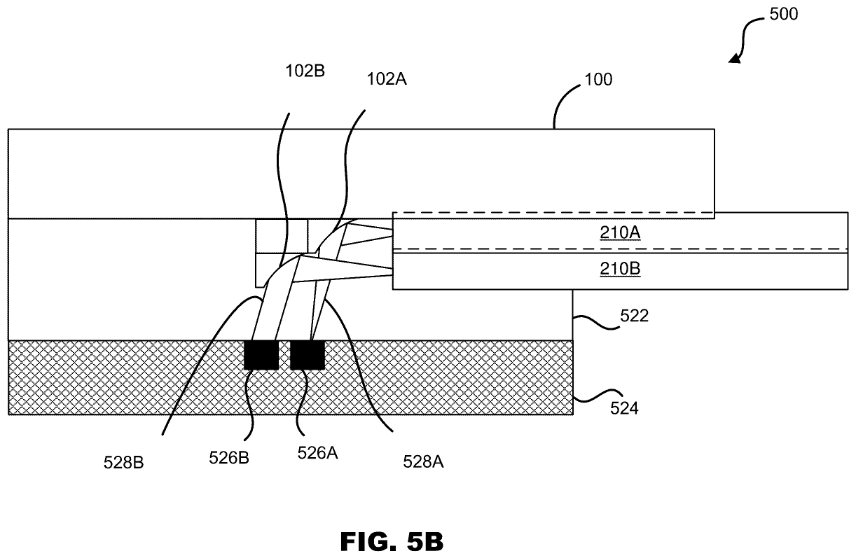

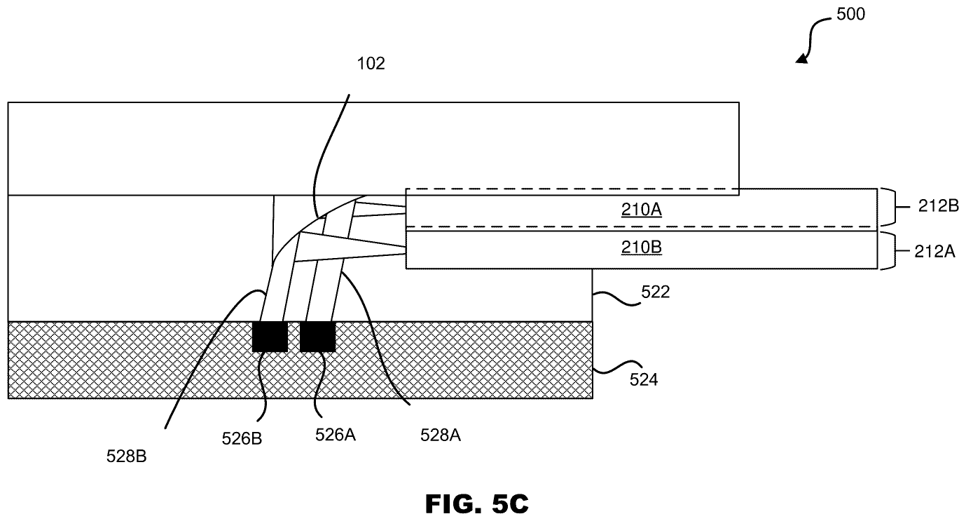

FIGS. 5A and 5B show example multi-layer optical coupling systems 500. The coupling system 500 may comprise a photonic plug 100. The photonic plug may be connected to one or more optical components, for example, optical fibers 210A and 210B (generally, optical fibers 210) (e.g., as described with reference to FIGS. 1A-4). The photonic plug 100 may facilitate coupling of light beams 528A and 528B (generally, light beam 528) (e.g., optical signal, light, etc.) between the optical fibers 210 and a second optical component, for example, photonic integrated circuit (PIC) 524. Particularly, PIC 524 may comprise transceivers 526A and 526B (generally, transceiver 526). Each of transceivers 526A and 526B may be optically coupled to a respective optical fiber 210A and 210B via the photonic plug 100 (e.g., via mirrors 102A and 102B of the photonic plug 100). Transceivers 526 may comprise, for example, a(n) input, output, input/output, transmitter, receiver, and/or transmitter/receiver. Also or alternatively, transceiver 526 may comprise, for example, a waveguide, a mirror waveguide pair, a grating coupler, a lensed mirror, a lens, a laser, a fiber, a photonic bump, etc. The transceivers 526 may be configured to be coupled to a substantially collimated light beam 528 (e.g., as depicted in FIG. 5A) or a substantially focusing light beam (e.g., as depicted in FIG. 5B).

The photonic plug 100 may be arranged proximate to a spaced layer 522. The spaced layer 522 may comprise a spacer. For example, the spaced layer 522 may comprise an adhesive (e.g., epoxy) layer (e.g., as described herein). Also or alternatively, the spaced layer 522 may comprise a glass substrate (e.g., substantially as described herein, for example with reference to FIGS. 3-4). Also or alternatively, the spaced layer 522 may comprise empty space (in such a configuration, the photonic plug 100 and/or PIC may comprise one or more features spacing the photonic plug and the PIC). Also or alternatively, the spaced layer 522 may comprise a liquid between the photonic plug 100 and the PIC. The spaced layer 522 may be configured such that the one or more media (e.g., epoxy, glass, liquid coolant, etc.) in the spaced layer may comprise a particular index of refraction. The index of refraction may be selected to facilitate the travel and/or propagation of the light 528 through the spacer. The index of refraction may be selected to effect and/or facilitate optical coupling of the optical fibers 210A and 210B (e.g., first optical components) to the PIC 524 and/or the transceivers 526A and 526B (e.g., second optical component(s)). The spaced layer 522 may comprise an interposer substrate. The interposer substrate may be configured to facilitate optical coupling (e.g., as described) and/or configured to facilitate electrical coupling (e.g., using electrical via, wire bonding, solder bumps, electrical traces, etc.).

As described herein, the mirrors 102 and may comprise one or more of, for example, curved mirrors, lensed mirrors, turning curved mirrors, and/or tilted flat (e.g., substantially flat) mirrors. Accordingly, mirrors 102 may be configured to turn (e.g., redirect) the light 528. Also or alternatively, mirrors 102 may be configured to transform the light 528. For example, mirrors 102 may be configured as lensed mirrors to, for example, collimate and/or focus the light 528. Also or alternatively, mirrors 102 may be configured to expand and/or contract the light 528. For example, the mirrors 102 may be configured as a lensed mirror that transform (e.g., expand, contract) a mode field diameter of the light 528. For example, the photonic plug 100 may be configured to couple light between optical components that use different mode field diameters. Accordingly, the mirrors 102 may be configured to transform the mode field diameters between the two components (e.g., the optical fiber 210A and the transceiver 526A). Different mirrors 102 on the same photonic plug 100 may be configured differently to manipulate and/or transform different light paths 528A and 528B (e.g., as depicted in FIG. 5B).

FIG. 5C shows an example multi-layer optical coupling system 500. Optical coupling system 500 may be partially or entirely comprised by, incorporated in, and/or enabled by an optical coupler. Referring to FIG. 5C, the photonic plug 100 may be used to facilitate optical connection of multiple layers of optical fibers. Optical fiber 210A may be an optical fiber of a first fiber layer 212A, and optical fiber 210B may be an optical fiber of a second fiber layer 212B (the layers may, e.g., extent into and/or out of the page of FIG. 5C). The photonic plug 100 may comprise a single mirror 102 to facilitate optical coupling of both optical fiber 210A and optical fiber 210B. Mirror 102 may be variously configured along its surface to facilitate such optical connections. For example, optical fiber 210B may be further from the surface of mirror 102 than optical fiber 210A. To compensate, a first area of the surface of the mirror 102 that interacts with light 528A from fiber 210A may be differently configured from a second area of the surface of the mirror 102 that interacts with light 528B from mirror 102B. For example, the first area of the mirror 102 and the second area of the mirror 102B may comprise different focal lengths. Mirror 102 of FIG. 5C may be substantially similar to other mirrors 102 described herein unless explicitly described. Mirror 102 may be configured to interact with light associated with all or a portion of fibers 210 of first and second fiber layers 212A and 212B. Alternatively, mirror 102 may be configured to interact with light from a subset of the fibers 210 of the first and second fiber layers 212A and 212B.

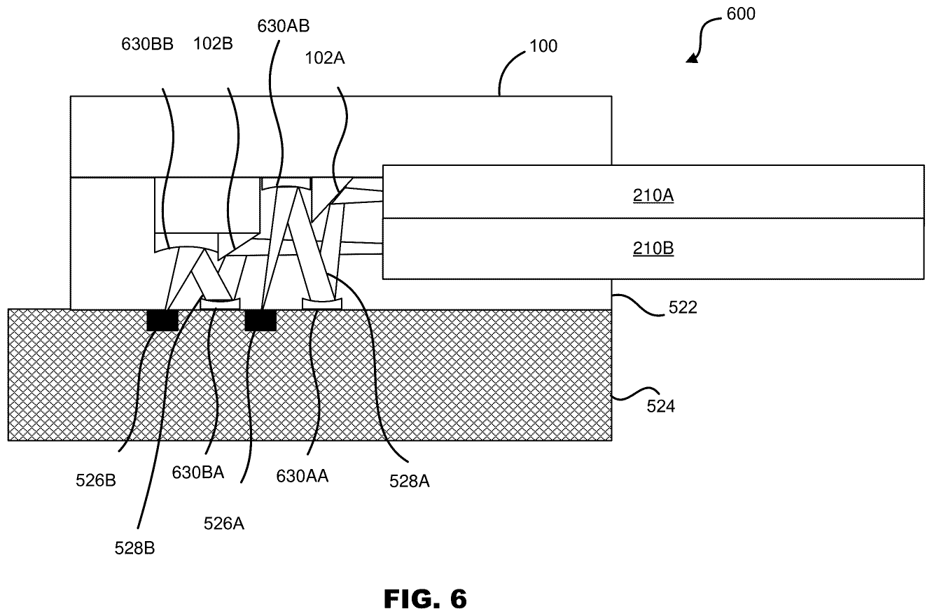

FIG. 6 shows an example multi-layer optical coupling system 600. The multi-layer optical coupling system 600 may be comprised and/or enabled by an optical coupler. Referring to FIG. 6, the photonic plug 100 may be configured to facilitate self-aligning optical coupling, for example, substantially as described in co-owned U.S. application Ser. No. 17/989,303, incorporated herein by reference in its entirety. The photonic plug 100 depicted in FIG. 6 may comprise a first side of the coupling system 600. The PIC 524 may comprise a second side of the coupling system. The second side may comprise a first curved mirror 630AA. The curved mirror 630AA may, for example, be disposed on the PIC 524. The curved mirror 630AA may be fabricated with and/or on the PIC 524 substrate or assembled (e.g., micro-assembled) to the PIC 524. For example, the first curved mirror 630AA (and fourth curved mirror 630BA) may be fabricated on a carrier (e.g., carrier substrate, e.g., silicon carrier substrate, glass carrier substrate, etc.). The carrier (e.g., comprising the first curved mirror 630AA) may be mated to the PIC 524 (e.g., PIC substrate). For example, the PIC 524 may be configured to engage with (e.g., receive, align, etc.) the carrier. The photonic plug 100 side may comprise a second curved mirror 630AB. The first curved mirror 630AA and the second curved mirror 630AB may be configured to face substantially opposing directions. The first curved mirror 630AA and the second curved mirror 630AB may be configured to be vertically (e.g., in the z-direction) offset from each other. Also or alternatively, the first curved mirror 630AA and the second curved mirror 630AB may be laterally (e.g., in the x and/or y directions) offset and/or distanced from each other.

The first curved mirror 630AA and the second curved mirror 630AB (generally, curved mirrors 630) may be configured as focusing mirrors (e.g., optical focusing elements). Accordingly, the curved mirrors 630 may be configured to transform, for example, to focus and/or collimate light 528. As described herein, the coupling system 600 may be used to optically couple optical components, for example, one or more optical fibers 210 to one or more PICs 524. The one or more PICS 524 may comprise one or more transceivers 526 (e.g., for receiving and/or transmitting the light 528).

Using the coupling system 600, light 528 can be coupled between the PIC 524 (e.g., transceiver 526A of the PIC 524) and the optical fiber 210A. The light can be relayed and/or directed between the transceiver 526A and the optical fiber 210A via the mirror 102A, the first curved mirror 630AA, and the second curved mirror 630AB. The configuration and arrangements of the mirrors 102 and curved mirrors 630 may enable self-aligning optics by correcting and/or allowing for some misalignment between the photonic plug 100 and the PIC 524 in at least the x, y, and z directions.

The second curved mirror 630AB may be disposed proximate and/or adjacent to the corresponding mirror 102A. The photonic plug 100 may comprise a multi-layer photonic plug 100, as described herein. Accordingly, the photonic plug 100 may comprise multiple rows of mirrors 102, and each of the photonic plug 100 may further comprise, for each row of mirrors 102, a row of curved mirrors 630. For example, mirror 102A may be of a first row of mirrors, and mirror 102B may be of a second row of mirrors. The photonic plug 100 may further comprise a first curved mirror 630AB, of the first row, corresponding to the mirror 102A of the first row. The photonic plug 100 may further comprise mirror 102B of a second row of mirrors and third curved mirror 630BB, of the second row, corresponding to the mirror 102B of the second row.

The PIC may further include fourth curved mirror 630BA. The fourth curved mirror 630BA may be substantially similar to first curved mirror 630AA unless otherwise described. Although FIG. 6 only depicts two rows (and therefore, two layers), a photonic plug 100 may comprise additional rows (and layers). Each row can comprise self-aligning optical coupling, as described herein. Accordingly, features of the present disclosure can be used to facilitate high bandwidth density self-aligning optics.

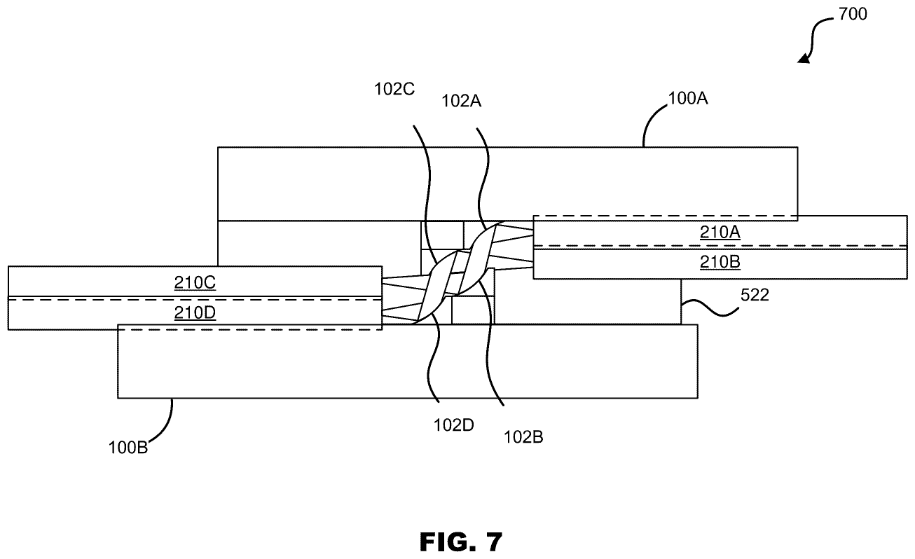

FIG. 7 shows an example multi-layer optical coupling system 700. The multi-layer optical coupling system 700 may be comprised and/or enabled by an optical coupler. Fiber-to-PIC optical coupling has been described. The apparatuses, systems, and methods of the present disclosure can also be used to couple fiber to fiber. Referring to FIG. 7, optical coupling system 700 may comprise two photonic plugs 100A and 100B (generally, photonic plug 100). Each of photonic plugs 100A and 100B may be substantially similar to the photonic plugs 100 described herein unless explicitly stated otherwise. The photonic plugs 100A and 100B may be substantially identical to each other. The first photonic plug 100A may be disposed opposite to second photonic plug 100B. First fiber 210A (e.g., of a first fiber row) and second fiber 210B (e.g., of a second fiber row) may be connected to the first photonic plug 100A. Third fiber 210C (e.g., of a third fiber row) and fourth fiber 210D (e.g., of fourth fiber row) may be connected to the second photonic plug 100B. The first fiber 210A may be optically coupled to the third fiber 210C, for example, via first mirror 102A and second mirror 102B. The second fiber 210B may be connected to the fourth fiber 210D, for example, via third mirror 102C and fourth mirror 102D. Similarly, each fiber may belong to a row of fibers, and the photonic plugs 100A and 100B may facilitate the optical connection of the multiple rows of fibers.

Similarly, the features of the present disclosure can be used to couple chip to chip (e.g., PIC to PIC. For example, the first photonic plug 100A and the second photonic plug 100B of FIG. 7 may be replaced with a first PIC and a second PIC. The first and second PICS may each comprise transceivers (e.g., as described herein). Transceivers of the first PIC may be coupled to transceivers of the second PIC, for example, via mirrors, for example, as substantially described herein.

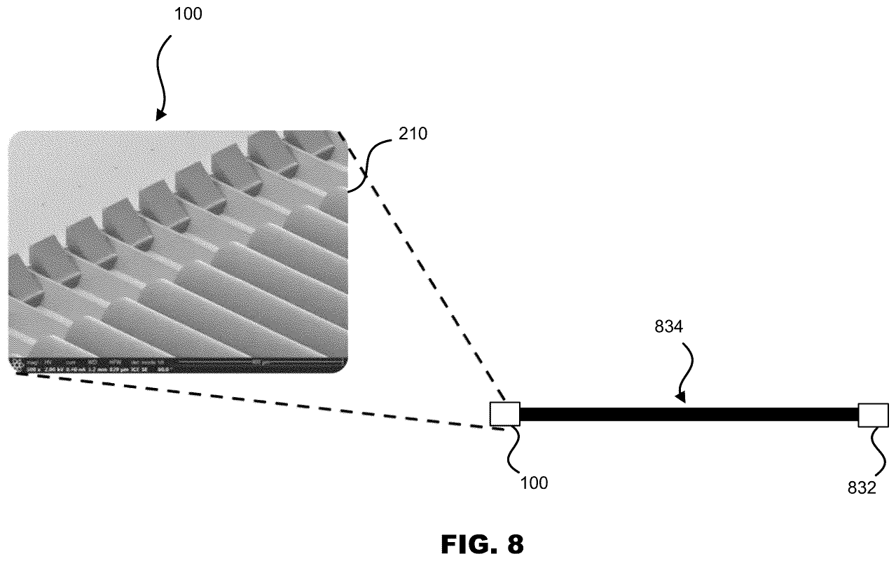

FIG. 8 shows fiber ribbon 834 connected to a photonic plug 100 and connector 832. Referring to FIG. 8, as described herein, a first plurality of fibers 210 may be connected to a photonic plug 100. A second plurality of fibers 210 may be connected to the first plurality of fiber 210 and/or to the photonic plug 100. The first and/or second plurality of fibers 210 may be part of a fiber ribbon 834 or a plurality of fiber ribbons 834. The fiber ribbon(s) 834, at a first end thereof, may be connected to the photonic plug 100. The fiber ribbon(s) 834, at a second end thereof, may be connected to one or more fiber connectors 832. The photonic plug 100 may also be referred to as a fiber connector. The fiber connectors 832 may comprise, for example, one or more of a photonic plug 100, a multi-fiber push-on (MPO) connector, a mechanical transfer (MT) connector, an angled physical contact (APC) connector, a physical contact (PC) connector, etc. The fiber ribbon(s) 834 can be connected to any number of connectors 832.

Features herein have been described with referential terms, for example, “top,” “bottom,” “underside,” “top-side,” “bottom-side,” and similar. Such terms have been used for ease of description and understanding. However, such terms should not be construed as limiting.

Although examples are described above, features and/or steps of those examples may be combined, divided, omitted, rearranged, revised, and/or augmented in any desired manner. Various alterations, modifications, and improvements will readily occur to those skilled in the art. Such alterations, modifications, and improvements are intended to be part of this description, though not expressly stated herein, and are intended to be within the spirit and scope of the disclosure. Accordingly, the foregoing description is by way of example only and is not limiting.

What is claimed is:

1. A system comprising:
a substrate configured to receive a first plurality of optical fibers, the substrate comprising:
a first plurality of mirrors; and
a second plurality of mirrors;
the first plurality of optical fibers disposed on the substrate;
a second plurality of optical fibers disposed on the first plurality of optical fibers; and
a photonic chip, wherein the first plurality of mirrors are configured to optically couple the first plurality of optical fibers to the photonic chip and wherein the second plurality of mirrors are configured to optically couple the second plurality of optical fibers to the photonic chip.

2. The system of claim 1, wherein the substrate further comprises a plurality of trenches, each of the trenches being configured to engage an optical fiber of the first plurality of optical fibers.

3. The system of claim 2, wherein the plurality of trenches are configured to align the first plurality of optical fibers with the first plurality of mirrors.

4. The system of claim 1, wherein the first plurality of optical fibers define, on a topside thereof, a plurality of channels, wherein the second plurality of optical fibers are disposed in the plurality of channels.

5. The system of claim 4, wherein the plurality of channels facilitate alignment of the second plurality of optical fibers with the second plurality of mirrors.

6. The system of claim 1, wherein each of the first plurality of mirrors comprises a lensed mirror.

7. The system of claim 1, wherein each of the plurality of second mirrors comprises a lensed mirrors.

8. The system of claim 1, wherein each of the plurality of first mirrors is configured to redirect light being communicated between one of the first plurality of optical fibers and the photonic chip.

9. The system of claim 1, wherein each of the plurality of second mirrors is configured to redirect light being communicated between one of the second plurality of optical fibers and the photonic chip.

10. The system of claim 1, wherein each of the plurality of first mirrors is configured to transform light being communicated between one of the first plurality of optical fibers and the photonic chip.

11. The system of claim 10, wherein the transformation comprises one or more of:
collimating;
focusing; and
expanding.

12. The system of claim 1, wherein each of the plurality of second mirrors is configured to transform light being communicated between one of the second plurality of optical fibers and the photonic chip.

13. The system of claim 12, wherein the transformation comprises one or more of:
collimating;
focusing; and
expanding.

14. The system of claim 1, wherein each of the first plurality of mirrors and each of the second plurality of mirrors comprises a tilted substantially flat mirror.

15. The system of claim 1, wherein the photonic chip further comprises one or more transceivers, each transceiver being optically coupled, via one of the mirrors, to one of the optical fibers.

16. The system of claim 15, wherein each transceiver comprises one or more of:
a lensed mirror;
a grating coupler;
a waveguide; and
a laser.

17. The system of claim 1, further comprising a spacer substrate disposed between the first plurality of optical fibers and the second plurality of optical fibers.

18. The system of claim 1, wherein a first portion of the first and second plurality of optical fibers comprises single mode optical fibers and wherein a second portion of the first and second optical fibers comprises polarization maintaining (PM) optical fibers.

19. The system of claim 1, wherein the first and second plurality of optical fibers:
at a first end thereof, are engaged with the substrate; and
at a second end thereof, are engaged with one or more connectors.

20. The system of claim 1, wherein the one or more connectors comprise one or more of:
a multi-fiber push on (MPO) connector;
a mechanical transfer (MT) connector;
an angled physical contact (APC) connector; and
a physical contact (PC) connector.
